(19) United States
(12) Patent Application Publication
(10) Pub. No.: US 2024/0141163 A1
(43) Pub. Date: May 2, 2024

(54) BIODEGRADABLE CONTAINERS AND RESIN THEREFOR

(71) Applicant: Danimer IPCo, LLC, Bainbridge, GA (US)

(72) Inventors: Karson Durie, Athens, GA (US); Michael N, Mang, Bainbridge, GA (US)

(73) Assignee: Danimer IPCo, LLC, Bainbridge, GA (US)

(21) Appl. No.: 18/408,788

(22) Filed: Jan. 10, 2024

Related U.S. Application Data
(62) Division of application No. 17/482,751, filed on Sep. 23, 2021.
(60) Provisional application No. 63/082,551, filed on Sep. 24, 2020.

(51) Int. Cl. C08L 67/04; B65D 65/46; C08G 63/06; C08K 5/00

(52) U.S. Cl. CPC C08L 67/04; B65D 65/466; C08G 63/06; C08K 5/0083; C08L 2201/06

(57) ABSTRACT

A biodegradable preform, biodegradable containers and a method for making the plastic containers. The biodegradable container wherein the body of the container includes from about 40 to about 99 weight percent of a polymer derived from random monomeric repeating units having a structure of

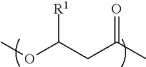

wherein R¹ is selected from the group consisting of CH₃ and a C₃ to C₁₉ alkyl group. The monomeric units wherein R¹ is CH₃ is about 75 to about 99 mol percent of the polymer. A resin adapted for forming the container is also disclosed.

### TECHNICAL FIELD

The disclosure is directed to biodegradable containers and in particular compositions and methods for making biodegradable containers.

### BACKGROUND AND SUMMARY

With the current plastics crisis, plastics are being continuously replaced with bio-friendly alternatives. One large contributor to the plastic problem is poly(ethylene terephthalate) (PET) water bottles. It is estimated that in 2017 one million PET water bottles were sold every minute. Considering that it takes ˜450 years for a PET bottle to completely degrade, the earth is becoming over-polluted with PET bottles. Furthermore, while PET can be recycled, some developed countries, such as the US, only recycle a fraction of the PET bottles used, and other less-developed countries do not have a recycling system at all. In these countries with no recycling infrastructure, the PET bottles often end up in the ocean, breaking down into microplastics that begin to damage the ecosystem as the marine life consume them, mistaking them for food.

While other biopolymers are available as alternatives to PET, very few are viable for a replacement, being hard to mold, such as poly(butylene succinate) or if able to be molded into bottles, having dismal barrier properties, such as bottles made from poly(lactic acid). Additionally, few biopolymers are able to degrade in an acceptable amount of time or without the use of high temperatures/pressures. Poly(hydroxyalkanoate), referred to herein as “PHA,” is an excellent alternative for PET, as it degrades quickly without the need for external measures and can be formulated to be molded.

Currently, PET bottles are made through reheat injection stretch blow molding of preforms. PET bottle molding can be conducted in either a one-step or a two-step process. In a one-step process, preforms are injection molded into a preform mold with the desired neck finish and preform geometry. Then, on the same equipment, the preforms are conditioned through heaters and blown into a bottle mold using air and a stretch rod. The two-step process is similar, but the preforms are injected on a separate injection press. After injection, the preforms are reheated and blown into a bottle mold with a stretch rod and air. Currently, most bottles are made using a two-step process, as the preforms can be made, transported, and stored prior to blowing, thereby maximizing production.

In view of the foregoing, PHA containers, including bottles are provided that are highly biodegradable. The PHA containers are made by modifying PHA with melt strength enhancers, chain extenders, and other processing aids. Preforms were injected molded into many different types of preforms with a variety of designs and neck finishes. Containers may be made through two-stage reheat stretch blow molding, though evidence suggests that PHA containers may be also made through a one-stage process or through injection blow molding. With the formulations provided, the PHA should degrade rapidly, but the degradation kinetics will depend on the design of the container, with thicker walled containers taking longer to fully degrade. The containers made according to the disclosure may be labeled with PHA labels and closed with PHA closures so that the entire container is biodegradable.

In some embodiments, the disclosure provides a biodegradable preform, a biodegradable container and a method for making the biodegradable container. The biodegradable container has a body and a closure therefor, the body of the container includes from about 40 to about 99 weight percent of a polymer derived from random monomeric repeating units having a structure of

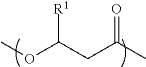

wherein R¹ is selected from the group consisting of CH₃ and/or a C₃ to C₁₉ alkyl group. The monomeric units wherein R¹ is CH₃ is about 75 to about 99 mol percent of the polymer.

The body of the container also typically includes from about 0.1 to about 10 weight percent of at least one nucleating agent and from about 0.005 to about 3 weight percent of at least one melt strength enhancer.

In some embodiments, the body of the biodegradable container and the preform include from about 40 to about 99 weight percent of poly(hydroxyalkanoate) copolymer and from about 1 to about 60 wt. % additional additives.

In some embodiments, the biodegradable container includes polyhydroxybutyrate as the poly(hydroxyalkanoate).

In other embodiments, the poly(hydroxyalkanoate) copolymer includes poly-3-hydroxybutyrate-co-3-hydroxyhexanoate (P3HB-co-P3HHx).

In some embodiments, the body of the biodegradable container and the preform further include from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

In some embodiments, the body of the biodegradable container and the preform further include poly(hydroxyalkanoate)s that include a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of poly(hydroxyhexanoate), poly(hydroxyoctanoate), poly(hydroxydecanoate), and mixtures thereof.

In some embodiments the polymer of the biodegradable container and the preform has a weight average molecular weight ranging from about 50 thousand Daltons to about 2.5 million Daltons.

In other embodiments, the polymer of the biodegradable container and the preform further includes from about 0.1 weight percent to about 10 weight percent of at least one nucleating agent selected from erythritols, pentaerythritols, dipentaerythritols, artificial sweeteners, stearates, sorbitols, mannitols, inositols, polyester waxes, nanoclays, polyhydroxybutyrate, boron nitride, and mixtures thereof.

In some embodiments, the biodegradable container and the preform further include from about 0.05 weight percent to about 3 weight percent at least one melt strength enhancer chosen from the group consisting of a multifunctional epoxide; an epoxy-functional, styrene-acrylic polymer; an organic peroxide; an oxazoline; a carbodiimide; and mixtures thereof. In some embodiments, the amount of the melt strength enhancer is from about 0.05 to about 1 weight percent.

In some embodiments the biodegradable container and the preform further include from about 1 weight percent to about 60 weight percent of polymers selected from the group consisting of poly(lactic acid), poly(caprolactone), poly(ethylene sebicate), poly(butylene succinate), and poly(butylene succinate-co-adipate), and copolymers and blends thereof.

In some embodiments, the polymer and the preform further include from about 0.1 weight percent to about 5 weight percent of a reheat agent selected from carbon black, infrared absorbing pigments, and mixtures thereof.

In other embodiments, the polymer and preform further include from about 0.1 weight percent to about 20 weight percent of a filler selected from calcium carbonate, talc, starch, zinc oxide, neutral alumina, and mixtures thereof. In some embodiments, the amount of filler is more preferably from about 0.1 to about 10 weight percent.

In some embodiments, the biodegradable container and preform further include from about 0.1 weight percent to about 5 weight percent polymeric fibers for structural support, such as stereocomplexed poly(lactic acid) (PLA) fibers.

In some embodiments, the biodegradable container and preform further comprise from about 0.1 weight percent to about 3 weight percent of a fatty acid amide slip agent.

In other embodiments, the biodegradable container and preform further comprises up to about 15 weight percent of a plasticizer selected from sebacates; citrates; fatty esters of adipic acid, succinic acid, and glucaric acid; lactates; alkyl diesters; alkyl methyl esters; dibenzoates; propylene carbonate; caprolactone diols having a number average molecular weight from about 200 to about 10,000 g/mol; poly(ethylene) glycols having a number average molecular weight of about 400 to about 10,000 g/mol; esters of vegetable oils; long chain alkyl acids; adipates; glycerols; isosorbide derivatives or mixtures thereof; polyhydroxyalkanoate copolymers comprising at least 18 mole percent monomer residues of hydroxyalkanoates other than hydroxybutyrate; and mixtures thereof.

In some embodiments, the biodegradable container undergoes degradation according to TUV Austria Program OK 12. In other embodiments, the biodegradable container has a shelf-life of at least 24 months, as determined in accordance with ASTM E2454. In some embodiments, the biodegradable container has a moisture vapor transmission rate of about 20 g/m²/day or less as measured under ASTM E96.

In some embodiments, there is provided a method for making a biodegradable container from biodegradable preform by forming the container in a one-step or two-step process selected from reheat stretch blow molding and injection blow molding.

In other embodiments, there is provided a method for making a biodegradable container by forming the container via extrusion blow molding, wherein the container is molded from a molten parison.

In some embodiments, the biodegradable preform is molded into a biodegradable container having a volume ranging from about 5 mL to about 25 L.

In certain embodiments, the container body is a unitary structure which is blow molded from a single pre-form.

Alternatively, in other embodiments, the container may be formed by thermoforming, vacuum forming, injection molding, compression molding, or rotomolding.

In another aspect, the disclosure also provides a resin which is adapted for forming the biodegradable preform and the biodegradable container described above. The resin is made up of poly(hydroxyalkanoate) and optionally other polymers, as well as other additives as described above with respect to the biodegradable container.

### DETAILED DESCRIPTION

The present invention answers the need for a biodegradable containers and biodegradable materials that is capable of being easily processed into a plastic container. The biodegradable materials and containers made therefrom answer a need for disposable containers having increased biodegradability and/or compostability.

As used herein, “ASTM” means American Society for Testing and Materials.

As used herein, “alkyl” means a saturated carbon-containing chain which may be straight or branched; and substituted (mono- or poly-) or unsubstituted.

As used herein, “alkenyl” means a carbon-containing chain which may be monounsaturated (i.e., one double bond in the chain) or polyunsaturated (i.e., two or more double bonds in the chain); straight or branched; and substituted (mono- or poly-) or unsubstituted.

As used herein, “PHA” means a poly(hydroxyalkanoate) as described herein having random monomeric repeating units of the formula

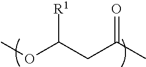

wherein R¹ is selected from the group consisting of CH₃ and a C₃ to C₁₉ alkyl group. The monomeric units wherein R¹ is CH₃ is about 75 to about 99 mol percent of the polymer.

As used herein, “P3HB” means the poly-(3-hydroxybutyrate).

As used herein, “P3HHx” means the poly(3-hydroxyhexanoate)

As used herein, “biodegradable” means the ability of a compound to ultimately be degraded completely into CO₂ and water or biomass by microorganisms and/or natural environmental factors, according to ASTM D5511 (anaerobic and aerobic environments), ASTM 5988 (soil environments), ASTM D5271 (freshwater environments), or ASTM D6691 (marine environments). Biodegradability can also be determined using ASTM D6868 and European EN 13432.

As used herein, “compostable” means a material that meets the following three requirements: (1) the material is capable of being processed in a composting facility for solid waste; (2) if so processed, the material will end up in the final compost; and (3) if the compost is used in the soil, the material will ultimately biodegrade in the soil according to ASTM D6400 for industrial and home compostability.

All copolymer composition ratios recited herein refer to mole ratios, unless specifically indicated otherwise.

Unless otherwise noted, all molecular weights referenced herein are weight average molecular weights, as determined in accordance with ASTM D5296.

In one embodiment of the present invention, at least about 50 mol %, but less than 100%, of the monomeric repeating units have CH₃ as R¹, more preferably at least about 60 mol %; more preferably at least about 70 mol %; more preferably at least about 75 to 98 mol %.

In another embodiment, a minor portion of the monomeric repeating units have R¹ selected from alkyl groups containing from 3 to 19 carbon atoms. Accordingly, the copolymer may contain from about 0 to about 30 mol %, preferably from about 1 to about 25 mol %, and more particularly from about 2 to about 10 mol % of monomeric repeating units containing a C₃ to C₁₉ alkyl group as R¹.

In some embodiments, a preferred PHA copolymer for use with the present disclosure is poly-3-hydroxybutyrate-co-3-hydroxyhexanoate (P3HB-co-P3HHx). In certain embodiments, this PHA copolymer preferably comprises from about 94 to about 98 mole percent repeat units of 3-hydroxybutyrate and from about 2 to about 6 mole percent repeat units of 3-hydroxyhexanoate.

### Synthesis of Biodegradable PHAs

Biological synthesis of the biodegradable PHAs in the present invention may be carried out by fermentation with the proper organism (natural or genetically engineered) with the proper feedstock (single or multicomponent). Biological synthesis may also be carried out with bacterial species genetically engineered to express the copolymers of interest (see U.S. Pat. No. 5,650,555, incorporated herein by reference.

### Crystallinity

The volume percent crystallinity (Φ_{c}) of a semi-crystalline polymer (or copolymer) often determines what type of end-use properties the polymer possesses. For example, highly (greater than 50%) crystalline polyethylene polymers are strong and stiff, and suitable for products such as plastic milk containers. Low crystalline polyethylene, on the other hand, is flexible and tough, and is suitable for products such as food wraps and garbage bags. Crystallinity can be

determined in a number of ways, including x-ray diffraction, differential scanning calorimetry (DSC), density measurements, and infrared absorption. The most suitable method depends upon the material being tested.

The volume percent crystallinity ((Dc) of the PHA copolymer may vary depending on the mol percentage of P3HHx in the PHA copolymer. The addition of P3HHx effectively lowers the volume percent crystallinity of the PHA copolymer, crystallization rate, and melting temperature while providing an increase in the flexibility and degradability of the copolymer. Nucleating agents, as described herein may be used to speed up the crystallization process of the PHA copolymers.

In general, PHAs of the present invention preferably have a crystallinity of from about 0.1% to about 99% as measured via x-ray diffraction; more preferably from about 2% to about 80%; more preferably still from about 20% to about 70%.

When a PHA of the present invention is to be processed into a molded article, the amount of crystallinity in such PHA is more preferably from about 10% to about 80% as measured via x-ray diffraction; more preferably from about 20% to about 70%; more preferably still from about 30% to about 60%.

### Melt Temperature

Preferably, the biodegradable PHAs of the present invention have a melt temperature (Tₘ) of from about 30° C. to about 170° C., more preferably from about 90° C. to about 165° C., more preferably still from about 130° C. to about 160° C.

### Molded Articles

According to the disclosure, a polymeric container is formed from a resin comprising a polymer or copolymer materials (e.g., PHA) which are injected, compressed, or blown by means of a gas into shape defined by a female mold. Alternatively, in other embodiments, the container may be formed by thermoforming, vacuum forming, injection molding, compression molding, or rotomolding. In particular, the molded articles may be plastic bottles that hold carbonated and non-carbonated liquids, as well as dry materials including, but not limited to powders, pellets, capsules, and the like.

Injection molding of thermoplastics is a multi-step process by which a PHA formulation of the present invention is heated until it is molten, then forced into a closed mold where it is shaped, and finally solidified by cooling. The preform resembles a tube with open and closed ends, wherein the open end may be threaded.

Reheat injection stretch blow molding is typically used for producing bottles and other hollow objects (see EPSE-3). In this process, a PHA preform is heated and then placed into a closed, hollow mold. The preform is then expanded by air and a stretch rod, forcing the PHA against the walls of the mold. Subsequent cooling air then solidifies the molded article in the mold. The mold is then opened and the article is removed from the mold.

Blow molding is preferred over injection molding for containers, as it is easier to make extremely thin walls in a blow molding process. Thin walls mean less PHA in the final product, and production cycle times are often shorter, resulting in lower costs through material conservation and higher throughput. Extrusion blow molding may also be used to produce thin-walled containers according to embodiments of the disclosure.

PHA containers were made by modifying PHA with melt strength enhancers, chain extenders, and other processing aids. Preforms were injected molded into many different types of preforms with a variety of designs and neck finishes. Containers were made through two-stage reheat stretch blow molding, though there may be evidence that suggests that PHA containers can be also made through a one-stage process or through injection blow molding.

The PHAs according to the disclosure may contain from about 40 to 99 weight percent of poly(hydroxyalkanoate) copolymer and from about 1 to about 60 wt. % polymer modifiers. In some embodiments, the poly(hydroxyalkanoate) copolymer is poly-3-hydroxybutyrate-co-3-hydroxyhexanoate (P3HB-co-P3HHx). In other embodiments, the PHA composition includes from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

In some embodiments, the PHA formulation used to make biodegradable containers may include from about 0.5 weight percent to about 15 weight percent of at least one plasticizer selected from the group consisting of sebacates, citrates, fatty esters of adipic, succinic, and glucaric acids, lactates, alkyl diesters, citrates, alkyl methyl esters, dibenzoates, propylene carbonate, caprolactone diols having a number average molecular weight from 200-10,000 g/mol, polyethylene glycols having a number average molecular weight of 400-10,000 g/mol, esters of vegetable oils, long chain alkyl acids, adipates, glycerol, isosorbide derivatives or mixtures thereof.

In other embodiments, the PHA formulation preferably also includes from about

0.1 weight percent to about 10 weight percent, or from about 0.1 to about 20 weight percent, of at least one nucleating agent selected from sulfur, erythritols, pentaerythritol, dipentaerythritols, inositols, stearates, sorbitols, mannitols, polyester waxes, compounds having a 2:1; 2:1 crystal structure chemicals, boron nitride, and mixtures thereof.

In certain preferred embodiments, the PHA formulation may include from about 0.1 to about 3 weight percent of a nucleating agent selected from boron nitride or pentaerythritol, and more preferably from about 0.3 to about 1.5 weight percent of boron nitride or pentaerythritol. Moreover, in instances in which boron nitride is used as a nucleating agent, the PHA formulation may also include from about 1 to about 5 weight percent of poly(hydroxybutyrate) homopolymer in addition to poly(hydroxyalkanoate) copolymer.

In some embodiments, the PHA formulation preferably includes from about 0 to about 1 percent by weight, such as from about 1 to about 0.5 percent by weight of a melt strength enhancer/rheology modifier. This melt strength enhancer may for instance be selected from the group consisting of a multifunctional epoxide; an epoxy-functional, styrene-acrylic polymer; an organic peroxide such as di-t-butyl peroxide; an oxazoline; a carbodiimide; and mixtures thereof.

Without being bound by theory, this additive is believed to act as a cross-linking agent to increase the melt strength of the PHA formulation. Alternatively, in some instances, the amount of the melt strength enhancer is from about 0.05 to about 3 weight percent. More preferred melt strength enhancers include organic peroxides, epoxides, and carbodiimides, preferably in an amount from about 0.05 to about 0.2 weight percent of the PHA formulation.

In some embodiments, the PHA formulation may include one or more performance enhancing polymers selected from poly(lactic acid), poly(caprolactone), poly(ethylene sebicate), poly(butylene succinate), and poly(butylene succinate-co-adipate), and copolymers and blends thereof. The performance enhancing polymers may be present in the formulation in a range of from about 1 to about 60 percent by weight. In some embodiments, from about 0.1 to about 15 weight percent of polylactic acid fibers are included in the polymer formulation for structural support of containers made from the polymer formulation.

In some embodiments, the polymer formulation includes from about 0.1 to about 5 weight percent of a reheat agent such as carbon black or another infrared absorbing material. In other embodiments, the polymer includes from about 0.1 to about 20 weight percent (preferably from about 0.1 to about 10 weight percent) of a filler selected from calcium carbonate, talc, starch, zinc oxide, neutral alumina, and mixtures thereof.

In some embodiments, the polymer formulation includes a slip agent. The most common slip agents are long-chain, fatty acid amides, such as erucamide and oleamide. One or more slip agents, for example calcium stearate or fatty acid amides is/are typically included in the polymer formulation. When included in the formulation, the amount of slip agent may range from about 0.1 to about 3 percent by weight of a total weight of the polymer formulation.

Exemplary formulations that may be used to make biodegradable containers according to the disclosure are shown in the following table.

| | PHA | PHA | PHA | | | | | | |
|---|---|---|---|---|---|---|---|---|---|
| | polymer | polymer | polymer | | | | | | |
| | wt. % | wt. % | wt. % | | | | | | |
| | 3 mol % | 6 mol % | 9 mol % | Weight % | | Weight % | | | Weight % |
| | Hexanoate | Hexanoate | Hexanoate | Polylactic | Weight % | Organic | Weight % | Weight % | Polylactic |
| Formula | in polymer | in polymer | in polymer | acid | Pentaerythritol | peroxide | Joncryl | Inositol | acid fibers |
| 1 | 59.34 | — | — | 39.56 | 1 | 0.1 | — | — | — |
| 2 | 69.23 | — | — | 29.67 | 1 | 0.1 | — | — | — |
| 3 | 79.12 | — | — | 19.78 | 1 | 0.1 | — | — | — |
| 4 | 99 | — | — | — | 1 | — | — | — | — |
| 5 | 94 | — | — | 5 | 1 | — | — | — | — |
| 6 | 98.9 | — | — | — | 1 | 0.1 | — | — | — |
| 7 | 65.87 | 32.93 | — | — | 1 | 0.2 | — | — | — |
| 8 | 98.8 | — | — | — | 1 | — | 0.2 | — | — |
| 9 | 24.7 | 74.1 | — | — | 1 | — | 0.2 | — | — |
| 10 | 49.4 | 49.4 | — | — | 1 | — | 0.2 | — | — |
| 11 | 74.1 | 24.7 | — | — | 1 | — | 0.2 | — | — |
| 12 | 93.8 | — | — | — | 1 | — | 0.2 | — | 5 |
| 13 | 49.4 | — | 49.4 | — | 1 | — | 0.2 | — | — |
| 14 | 74.1 | — | 24.7 | — | 1 | — | 0.2 | — | — |
| 15 | 98.2 | — | — | — | 1 | — | 0.8 | — | — |
| 16 | 97.8 | — | — | — | — | — | 0.2 | 2 | — |

With the formulations provided, the PHA should degrade rapidly, but the degradation kinetics will depend on the design of the container, with thicker walled materials taking longer to fully degrade. The containers are to be labeled with the PHA label and PHA closure detailed in other invention disclosures. It is preferred that the containers undergo degradation according to TUV Austria Program OK 12, have a shelf-life of at least 24 months, and have a moisture vapor transmission rate of about 20 g/m²/day or less as determined under ASTM E96. The containers may have a volume ranging from about 5 mL to about 25 L or more.

The present disclosure is also further illustrated by the following embodiments:

Embodiment 1. A biodegradable container having a body and a closure therefor, the body of the container comprising: from about 0.1 to about 10 weight percent of at least one nucleating agent; from about 0.05 to about 3 weight percent of at least one melt strength enhancer; and from about 40 to about 99 weight percent of a polymer derived from random monomeric repeating units having a structure of

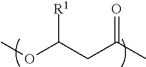

wherein R¹ is selected from the group consisting of CH₃ and a C₃ to C₁₉ alkyl group, wherein the monomeric units wherein R¹═CH₃ comprise 75 to 99 mol percent of the polymer.

Embodiment 2. The biodegradable container of Embodiment 1, wherein the body of the container comprises from about 40 to about 99 weight percent of poly(hydroxyalkanoate) copolymer and from about 1 to about 60 wt. % additional additives.

Embodiment 3. The biodegradable container of Embodiment 2 wherein the poly(hydroxyalkanoate) copolymer comprises poly-3-hydroxybutyrate-co-3-hydroxyhexanoate (P3HB-co-P3HHx).

Embodiment 4. The biodegradable container of Embodiment 1, wherein the body of the container further comprises from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

Embodiment 5. The biodegradable container of Embodiment 1, wherein the body of the biodegradable container further comprises poly(hydroxyalkanoate)s comprising a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of poly(hydroxyhexanoate), poly(hydroxyoctanoate), poly(hydroxydecanoate), and mixtures thereof.

Embodiment 6. The biodegradable container of Embodiment 1, wherein the polymer comprises poly(hydroxyalkanoate)s having a weight average molecular weight from about 50 thousand Daltons to about 2.5 million Daltons.

Embodiment 7. The biodegradable container of Embodiment 1, wherein the polymer further comprises from about 0.1 weight percent to about 10 weight percent of at least one nucleating agent selected from the group consisting of erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

Embodiment 8. The biodegradable container of Embodiment 1, wherein the body of the container further comprises from about 0.05 weight percent to about 3 weight percent at least one melt strength enhancer selected from the group consisting of a multifunctional epoxide; an epoxy-functional, styrene-acrylic polymer; an organic peroxide; an oxazoline; a carbodiimide; and mixtures thereof.

Embodiment 9. The biodegradable container of Embodiment 1, wherein the body of the container further comprises from about 1 weight percent to about 60 weight percent of polymers selected from the group consisting of poly(lactic acid), poly(caprolactone), poly(ethylene sebicate), poly(butylene succinate), and poly(butylene succinate-co-adipate), and copolymers and blends thereof.

Embodiment 10. The biodegradable container of Embodiment 1, wherein the polymer further comprises from about 0.1 weight percent to about 5 weight percent of a reheat agent selected from the group consisting of carbon black, infrared absorbing pigments, and mixtures thereof.

Embodiment 11. The biodegradable container of Embodiment 1, wherein the polymer further comprises from about 0.1 weight percent to about 20 weight percent of a filler selected from the group consisting of calcium carbonate, talc, starch, zinc oxide, neutral alumina, and mixtures thereof.

Embodiment 12. The biodegradable container of Embodiment 1, wherein the body of the container further comprises from about 0.1 weight percent to about 5 weight percent polymer fibers, such as polylactic acid (PLA) fibers for structural support.

Embodiment 13. The biodegradable container of Embodiment 1, wherein the body of the container further comprises from about 0.1 weight percent to about 3 weight percent of a fatty acid amide slip agent.

Embodiment 14. The biodegradable container of Embodiment 1, wherein the polymer further comprises up to about 15 weight percent of a plasticizer selected from the group consisting of sebacates; citrates; fatty esters of adipic acid, succinic acid, and glucaric acid; lactates; alkyl diesters; alkyl methyl esters; dibenzoates; propylene carbonate; caprolactone diols having a number average molecular weight from about 200 to about 10,000 g/mol; poly(ethylene) glycols having a number average molecular weight of about 400 to about 10,000 g/mol; esters of vegetable oils; long chain alkyl acids; adipates; glycerols; isosorbide derivatives or mixtures thereof; poly(hydroxyalkanoate) copolymers comprising at least 18 mole percent monomer residues of hydroxyalkanoates other than hydroxybutyrate; and mixtures thereof.

Embodiment 15. The biodegradable container of Embodiment 14, wherein the container is made by an extrusion blow molding process.

Embodiment 16. The biodegradable container of Embodiment 1, wherein the biodegradable container undergoes degradation according to ASTM D5511 (anaerobic and aerobic environments), ASTM 5988 (soil environments), ASTM D5271 (freshwater environments), ASTM D6691 (marine environments), ASTM D6868, or ASTM D6400 for industrial and home compostability (in soil).

Embodiment 17. The biodegradable container of Embodiment 1, wherein the biodegradable container has a moisture vapor transmission rate of about 20 g/m²/day or less as measured under ASTM E96.

Embodiment 18. The biodegradable container of Embodiment 1, wherein the biodegradable container has a shelf-life of at least 24 months.

Embodiment 19. A biodegradable preform suitable for use in making biodegradable containers, the preform comprising: from about 0.1 to about 10 weight percent of at least one nucleating agent; from about 0.05 to about 3 weight percent of at least one melt strength enhancer; and from about 40 to about 99 weight percent of a polymer derived from random monomeric repeating units having a structure of

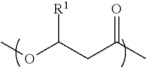

wherein R¹ is selected from the group consisting of CH₃ and a C₃ to C₁₉ alkyl group, wherein the monomeric units wherein R¹ is CH₃ comprise 75 to 99 mol percent of the polymer.

Embodiment 20. The biodegradable preform of Embodiment 19, wherein the biodegradable preform comprises from about 40 to about 99 weight percent of poly(hydroxyalkanoate) copolymer and from about 1 to about 60 wt. % additional additives.

Embodiment 21. The biodegradable preform of Embodiment 20, wherein the poly(hydroxyalkanoate) copolymer comprises poly-3-hydroxybutyrate-co-3-hydroxyhexanoate (P3HB-co-P3HHx).

Embodiment 22. The biodegradable preform of Embodiment 19, wherein the biodegradable preform comprises from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

Embodiment 23. The biodegradable preform of Embodiment 19, wherein the biodegradable preform comprises poly(hydroxyalkanoate)s having a weight average molecular weight from about 50 thousand Daltons to about 2.5 million Daltons.

Embodiment 24. The biodegradable preform of Embodiment 19, wherein the polymer further comprises from about 0.1 weight percent to about 10 weight percent of at least one nucleating agent selected from the group consisting of erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

Embodiment 25. The biodegradable preform of Embodiment 19, wherein the biodegradable preform comprises from about 0.05 weight percent to about 3 weight percent at least one melt strength enhancer selected from the group consisting of a multifunctional epoxide; an epoxy-functional, styrene-acrylic polymer; an organic peroxide; an oxazoline; a carbodiimide; and mixtures thereof.

Embodiment 26. The biodegradable preform of Embodiment 19, wherein the biodegradable preform further comprises from about 1 weight percent to about 60 weight percent of polymers to help with processing and to improve material properties selected from the group consisting of poly(lactic acid), poly(caprolactone), poly(ethylene sebicate), poly(butylene succinate), and poly(butylene succinate-co-adipate), and copolymers and blends thereof.

Embodiment 27. The biodegradable preform of Embodiment 19, wherein the biodegradable preform further comprises from about 0.1 weight percent to about 5 weight percent of a reheat agent, selected from the group consisting of carbon black, infrared absorbing pigments, and mixtures thereof.

Embodiment 28. The biodegradable preform of Embodiment 19, wherein the biodegradable preform further comprises from about 0.1 weight percent to about 20 weight percent of a filler selected from the group consisting of carbonate, talc, starch, zinc oxide, neutral alumina, and mixtures thereof.

Embodiment 29. The biodegradable preform of Embodiment 19, wherein the biodegradable preform further comprises from about 0.1 weight percent to about 5 weight percent polymer fibers, such as polylactic acid (PLA) fibers for structural support.

Embodiment 30. The biodegradable preform of Embodiment 19, wherein the biodegradable preform further comprises from about 0.1 weight percent to about 3 weight percent of a fatty acid amide slip agent.

Embodiment 31. A method for making a biodegradable container from biodegradable preform of Embodiment 19 comprising forming the container in a one-step or two-step process selected from the group consisting of reheat stretch blow molding and injection blow molding.

Embodiment 32. The method of Embodiment 31, wherein the biodegradable preform is molded into a biodegradable container having a volume ranging from about 5 mL to about 25 L.

Embodiment 33. The biodegradable container of Embodiment 1, wherein the container body is extrusion blow molded.

Embodiment 34. The biodegradable container of Embodiment 1, wherein the container body is injection blow molded.

Embodiment 35. The biodegradable container of Embodiment 1, wherein the container body is a unitary structure which is blow molded from a single pre-form.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A biodegradable container having a body and a closure therefor, the biodegradable container comprising:
from about 40 to about 99 weight percent of a poly(hydroxyalkanoate) copolymer derived from random monomeric repeating units having a structure of 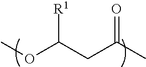
wherein R¹ is selected from the group consisting of CH₃ and a C₃ to C₁₉ alkyl group, wherein the copolymer comprises 75-99 mol % monomeric units having R¹ being CH₃ and the balance of monomeric units having R¹ being selected from C₃ to C₁₉ alkyl groups, wherein the poly(hydroxyalkanoate) copolymer comprises poly-3-hydroxybutyrate-co-3-hydroxyhexanoate (P3HB-co-P3HHx) and from about 1 to about 60 wt. % additional additives, wherein the additional additives comprise from about 0.1 to about 10 weight percent of at least one nucleating agent, and from about 0.05 to about 3 weight percent of a melt strength enhancer consisting essentially of a mixture of an organic peroxide and an oxazoline.

2. (canceled)

3. (canceled)

4. The biodegradable container of claim 1, wherein the the body of the biodegradable container further comprises from about 1.0 to about 15.0 weight percent of at least one poly(hydroxyalkanoate) comprising from about 25 to about 50 mole percent of a poly(hydroxyalkanoate) selected from the group consisting of poly(hydroxyhexanoate), poly(hydroxyoctanoate), poly(hydroxydecanoate), and mixtures thereof.

5. The biodegradable container of claim 1, wherein the the body of the biodegradable container further comprises a terpolymer made up from about 75 to about 99.9 mole percent monomer residues of 3-hydroxybutyrate, from about 0.1 to about 25 mole percent monomer residues of 3-hydroxyhexanoate, and from about 0.1 to about 25 mole percent monomer residues of a third 3-hydoxyalkanoate selected from the group consisting of 3-hydroxyoctanoate, 3-hydroxydecanoate, and mixtures thereof.

6. The biodegradable container of claim 1, wherein the poly(hydroxyalkanoate) copolymer has a weight average molecular weight ranging from about 50 thousand Daltons to about 2.5 million Daltons.

7. The biodegradable container of claim 1, wherein the at least one nucleating agent is selected from the group consisting of erythritols, pentaerythritol, dipentaerythritols, artificial sweeteners, stearates, sorbitols, mannitols, inositols, polyester waxes, nanoclays, polyhydroxybutyrate, boron nitride, and mixtures thereof.

8. (canceled)

9. The biodegradable container of claim 1, wherein the body of the biodegradable container further comprises from about 1 weight percent to about 60 weight percent of polymers selected from the group consisting of poly(lactic acid), poly(caprolactone), poly(ethylene sebacate), poly(butylene succinate), and poly(butylene succinate-co-adipate), and copolymers and blends thereof.

10. The biodegradable container of claim 1, wherein the additional additives further comprise from about 0.1 weight percent to about 5 weight percent of a reheat agent selected from the group consisting of carbon black, infrared absorbing pigments, and mixtures thereof.

11. The biodegradable container of claim 1, wherein the additional additives further comprise from about 0.1 weight percent to about 20 weight percent of a filler selected from the group consisting of calcium carbonate, talc, starch, zinc oxide, neutral alumina, and mixtures thereof.

12. The biodegradable container of claim 1, wherein the body of the biodegradable container further comprises from about 0.1 weight percent to about 5 weight percent polymer fibers for structural support.

13. The biodegradable container of claim 1, wherein the additional additives further comprise from about 0.1 weight percent to about 3 weight percent of a fatty acid amide slip agent.

14. The biodegradable container of claim 1, wherein the additional additives further comprise from about 15 weight percent of a plasticizer selected from the group consisting of sebacates; citrates; fatty esters of adipic acid, succinic acid, and glucaric acid; lactates; alkyl diesters; alkyl methyl esters; dibenzoates; propylene carbonate; caprolactone diols having a number average molecular weight from about 200 to about 10,000 g/mol; poly(ethylene) glycols having a number average molecular weight of about 400 to about 10,000 g/mol; esters of vegetable oils; long chain alkyl acids; adipates; glycerols; isosorbide derivatives or mixtures thereof; poly(hydroxyalkanoate) copolymers comprising at least 18 mole percent monomer residues of hydroxyalkanoates other than hydroxybutyrate; and mixtures thereof.

15. The biodegradable container of claim 1, wherein the biodegradable container undergoes degradation according to ASTM D5511 (anaerobic and aerobic environments), ASTM 5988 (soil environments), ASTM D5271 (freshwater environments), ASTM D6691 (marine environments), ASTM D6868, or ASTM D6400 for industrial and home compostability (in soil).

16. The biodegradable container of claim 1, wherein the biodegradable container has a moisture vapor transmission rate of about 20 g/m²/day or less as measured under ASTM E96.

17. The biodegradable container of claim 1, wherein the biodegradable container is made by an extrusion blow molding process.

18. The biodegradable container of claim 1, wherein the biodegradable container has a shelf-life of at least 24 months.

19. The biodegradable container of claim 1, wherein the biodegradable container body is a unitary structure which is blow molded from a single pre-form.

20. A method for making a biodegradable container from the poly(hydroxyalkanoate) copolymer of claim 1, comprising forming the biodegradable container in a one-step or two-step process selected from the group consisting of reheat stretch blow molding, extrusion blow molding, and injection blow molding.

21. The method of claim 20, wherein the biodegradable container has a volume ranging from about 5 mL to about 25 L.
